(19) United States
(12) Patent Application Publication
(10) Pub. No.: US 2024/0227689 A1
(43) Pub. Date: Jul. 11, 2024

(54) VEHICLE ROOF RAIL ATTACHMENT

(71) Applicant: Polestar Performance AB, Göteborg (SE)

(72) Inventor: Rob TANDY, Warwickshire (GB)

(73) Assignee: Polestar Performance AB, Göteborg (SE)

(21) Appl. No.: 18/558,947

(22) PCT Filed: May 7, 2022
(86) PCT No.: PCT/US2022/028218

§ 371 Date: Nov. 3, 2023

Related U.S. Application Data
(60) Provisional application No. 63/185,739, filed on May 7, 2021.

(51) Int. Cl. B60R 9/058

(52) U.S. Cl. CPC B60R 9/058

(57) ABSTRACT

An embedded roof rail mounting system for a motor vehicle, including a roof rail mount operably coupled to a vehicle body, the roof rail mount including a flanged head defining a recess shaped and sized to accommodate a portion of a roof rail, and a flip seal constructed of a resilient material configured to conceal the roof rail mount below an exterior surface of the motor vehicle.

### RELATED APPLICATION INFORMATION

This application claims the benefit of U.S. Provisional Application No. 63/185,739, filed May 7, 2021, the contents of which are fully incorporated herein by reference.

### TECHNICAL FIELD

The present disclosure relates generally to roof rail attachments for motor vehicles and more particularly to a vehicle body embedded roof rail mounting system concealed beneath a resilient flip seal onto which a roof rail can be operably coupled.

### BACKGROUND

Vehicle roof racks, alternatively referred to as luggage racks, typically include rigid assemblies used for transporting loads on the outside of a motor vehicle. Roof racks are commonly used to carry bulky items which may not fit in the cabin of the vehicle, such as luggage, bicycles, canoes, kayaks, skis, and various carriers and containers.

Most vehicle roof racks include at least one, but frequently two or more, rigid rails or bars secured to a roof of the motor vehicle. The rigid rails or bars typically extend laterally from side-to-side across the roof of the vehicle in a parallel arrangement. Often times, the rigid rails are operably coupled to the frame of the vehicle at their respective end regions, such that a midsection of each rigid rail is spaced apart from (e.g., above) the vehicle roof, thereby enabling the rigid rail to flex under the weight of the load without damaging non-structurally supported sections of the roof. For example, in some cases, the roof rails can be curved, such that each roof rail includes two end regions forming feet connected to the vehicle body, while a region of the roof rail located between the feet form a bridge between the two end regions.

Some motor vehicles have a factory installed permanent roof rack. Other vehicles have fittings for proprietary racks in which the roof rails are secured by special clamping carrier feet or clamping claws, which can be selectively clamped to the vehicle body. Although various vehicle roof rail attachment mechanisms have been proposed over the years, further improvements, particularly in aerodynamics, ease-of-use, and sleekness of design are desired. The present disclosure addresses these concerns.

### SUMMARY OF THE DISCLOSURE

The techniques of this disclosure generally relate to a vehicle body embedded roof rail mounting system including a flanged stud concealed beneath an exterior surface of a motor vehicle body beneath a resilient flip seal, thereby providing an aerodynamic design that does not interfere with a clean, sleek appearance of the vehicle, while providing a convenient and easy to use mechanism for the selective attachment of a roof rail.

One embodiment of the present disclosure provides an embedded roof rail mounting system for a motor vehicle, the embedded roof rail mounting system, including a roof rail mount operably coupled to a vehicle body, the roof rail mount including a flanged head defining a recess shaped and sized to accommodate a portion of a roof rail, and a flip seal constructed of a resilient material configured to conceal the roof rail mount below an exterior surface of the motor vehicle.

In one embodiment, the roof rail mount is formed of a two-part T-stud assembly, comprising an inner stud positionable within an outer sheath, wherein positioning the inner stud within the outer sheath causes a perimeter of the outer sheath to expand. In one embodiment, the roof rail mount is positioned within a recess of the vehicle body. In one embodiment, the embedded roof rail mounting system further includes a roof finisher operably coupled to the roof rail mount. In one embodiment, the roof finisher is operably coupled to the roof rail mount via a fastener passing through the roof finisher and received within a portion of the roof rail mount. In one embodiment, the roof finisher defines a first channel configured to receive an upper window seal. In one embodiment, the embedded roof rail mounting system further includes a vertical window seal operably coupled to the vehicle body adjacent to the upper window seal. In one embodiment, the upper window seal and the vertical window seal are arranged in an overlapping configuration. In one embodiment, the roof finisher defines a second channel configured to receive the flip seal. In one embodiment, the flip seal is deformable to provide selective access to the roof rail mount from an exterior surface of the vehicle. In one embodiment, the roof rail mount extends at an oblique angle with respect to a lateral axis of the vehicle body. In one embodiment, the oblique angle is in a range of between about 100° and about 140°.

Another embodiment of the present disclosure provides a motor vehicle including an embedded roof rail mounting system configured to enable selective attachment of one or more roof rails to respective roof rail mounts hidden beneath an exterior surface of the motor vehicle, including a motor vehicle body, two or more roof rail mounts operably coupled to the motor vehicle body, each roof rail mount including a flanged head defining a recess shaped and sized to accommodate a portion of a roof rail, and a flip seal on each side of the motor vehicle body constructed of the resilient material configured to conceal the two or more roof rail mounts below an exterior surface of the motor vehicle body.

In one embodiment, the roof rail mount is positioned within a recess of the motor vehicle body. In one embodiment, the motor vehicle further includes a roof finisher operably coupled to the roof rail mount. In one embodiment, the roof finisher defines a first channel configured to receive an upper window seal. In one embodiment, the roof finisher defines a second channel configured to receive the flip seal. In one embodiment, the flip seal is deformable to provide selective access to the roof rail mount from an exterior surface of the motor vehicle body. In one embodiment, the roof rail mount extends at an oblique angle with respect to a lateral axis of the motor vehicle body.

Another embodiment of the present disclosure provides an embedded roof rail mounting system for a motor vehicle, including a roof rail mount operably coupled to a recess of defined in the body of a motor vehicle, the roof rail mount including a flanged head defining a recess shaped and sized to accommodate a portion of a roof rail, wherein the roof rail mount is formed of a two-part T-stud assembly, comprising an inner stud positionable within an outer sheath, wherein positioning the inner stud within the outer sheath causes a perimeter of the outer sheath to expand, and wherein the roof rail mount extends at an oblique angle in a range of between about 100° and about 140° with respect to a lateral axis of the vehicle body; a flip seal constructed of the resilient material configured to conceal the roof rail mount below an exterior surface of the body of a motor vehicle, wherein the flip seal is deformable to provide selective access to the roof rail mount from the exterior surface; a roof finisher operably coupled to the roof rail mount via a fastener passing through the roof finisher and received within a portion of the roof rail mount, wherein the roof finisher defines a first channel configured to receive an upper window seal and a second channel configured to receive the flip seal; and a vertical window seal operably coupled to the vehicle body adjacent to the upper window seal, wherein the upper window seal and the vertical window seal are arranged in an overlapping configuration.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a perspective view depicting a motor vehicle including an embedded roof rail mounting system, in accordance with an embodiment of the disclosure.

FIG. 1B is a perspective view depicting the motor vehicle of FIG. 1A, in which a pair of roof rails are operably coupled to the embedded roof rail mounting system, in accordance with an embodiment of the disclosure.

FIG. 2A is a partial, cross-sectional view depicting a motor vehicle body including an embedded roof rail mount located beneath a resilient flip seal, in accordance with an embodiment of the disclosure.

FIG. 2B is a partial, cross-sectional view depicting the motor vehicle body of FIG. 2A, wherein the resilient flip seal is peeled away from the frame and a portion of a roof rail is inserted at least partially underneath a portion of the embedded roof rail mount, in accordance with an embodiment of the disclosure.

FIG. 3 is a partial, perspective view depicting a motor vehicle body including an embedded roof rail mount, in accordance with an embodiment of the disclosure.

FIG. 4 is a partial, perspective view depicting a motor vehicle body including an embedded roof rail mount located beneath a roof finisher, in accordance with an embodiment of the disclosure.

FIG. 5 is a partial, perspective view depicting a motor vehicle body including an embedded roof rail mount concealed beneath a resilient flip seal, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

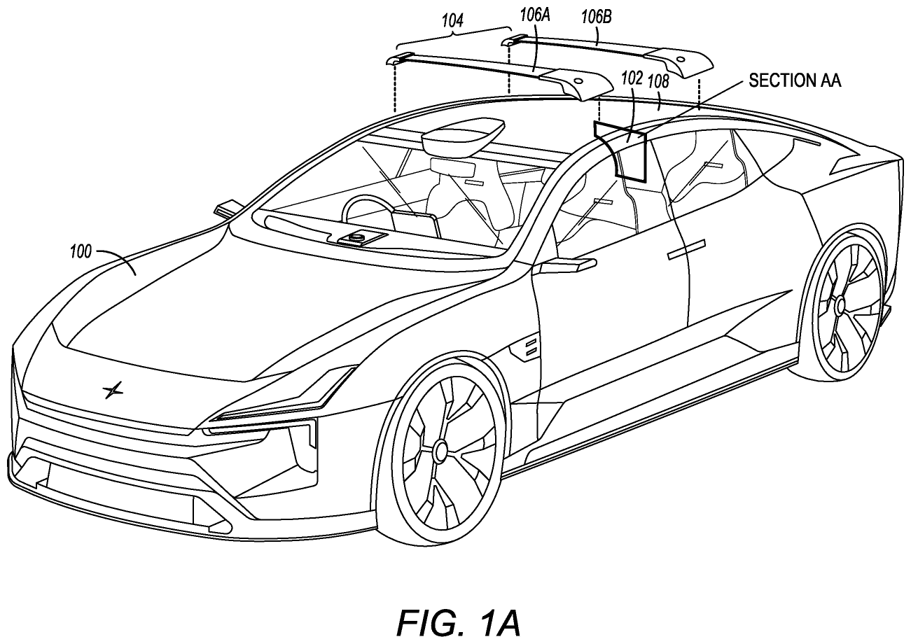

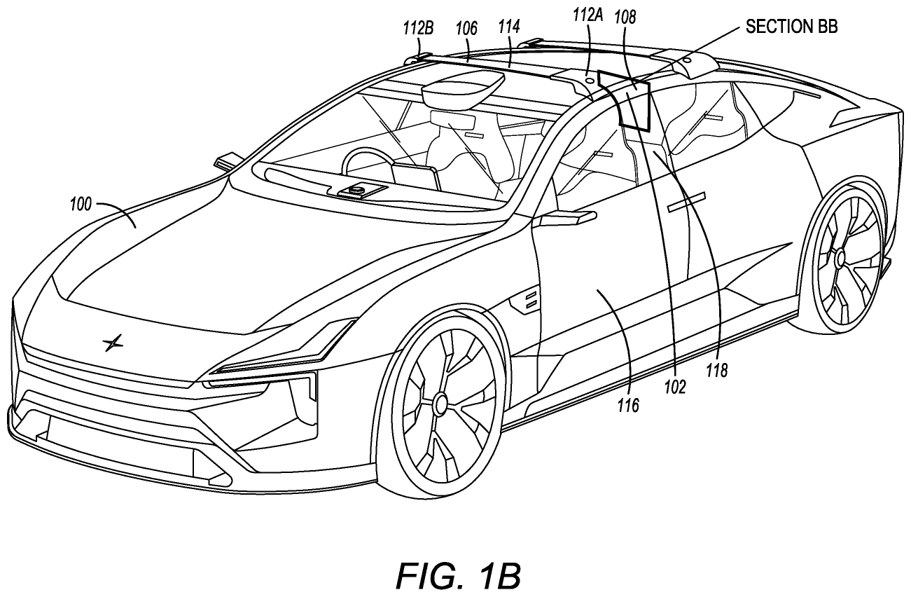

Referring to FIG. 1A, a motor vehicle 100 including an embedded roof rail mounting system 102 onto which a roof rack 104 or other carrier system can be operably coupled is depicted in accordance with an embodiment of the disclosure. As depicted, in some embodiments, the roof rack 104 can be in the form of a pair of rigid roof rails or bars 106A, 106B operably coupleable to the vehicle body 108; although other roof rack 104 configurations are also contemplated.

With additional reference to FIG. 1B, each roof rail 106 can extend laterally from side to side across a roof of the vehicle 100, such that the rigid rail 106 is operably coupled to the roof rail mounting system 102 at a respective end region 112A, 112B, with respect to a midsection 114, of the rigid rails 106, thereby enabling each roof rail 106 to flex under the weight of the load without impinging on or otherwise transferring any weight of the load to non-structurally supported regions of the vehicle body 108. For example, in some embodiments, the rigid rails 106 can be curved, such that each rigid rail 106 forms rigid arched beam between the respective end regions 112A, 112B; although other configurations of roof rails are also contemplated.

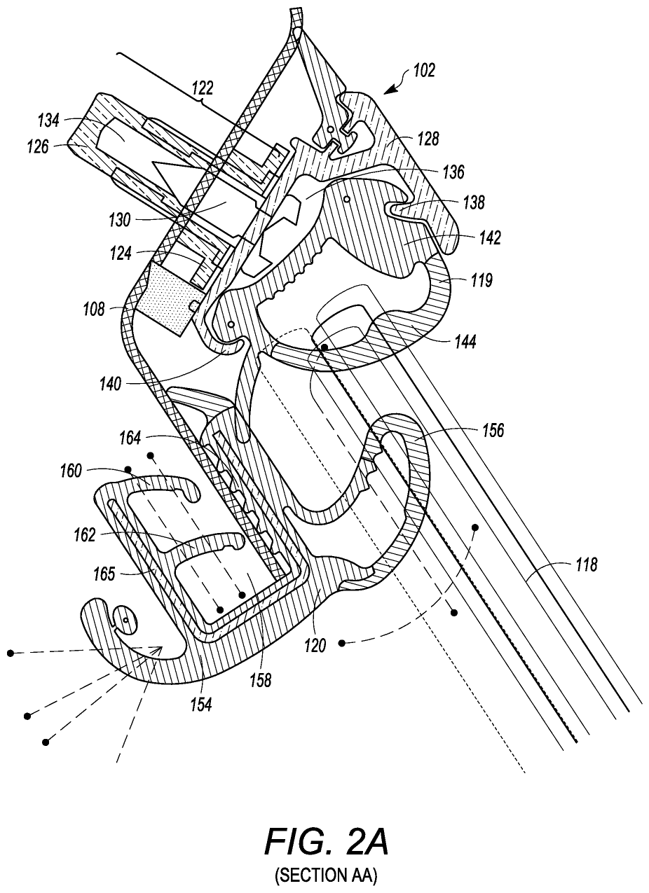

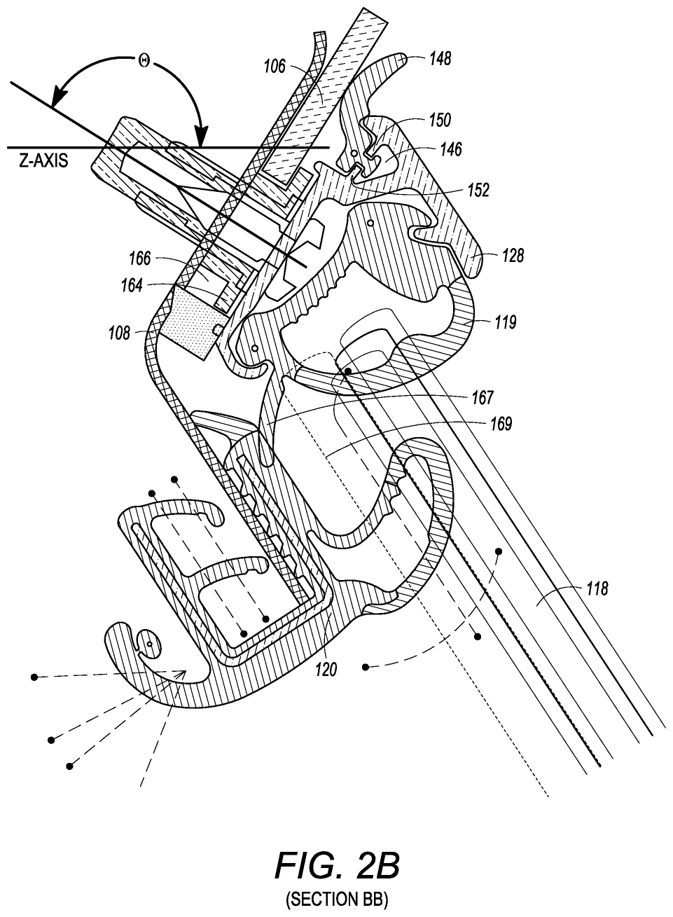

In some embodiments, the roof rack 104 can coupled to the vehicle body 108 adjacent to and above a door 116 of the vehicle 100. In some embodiments, the motor vehicle 100 can include one or more frameless doors 116, in which the one or more doors 116 do not include a structural window frame surrounding the windows 118, and the upper and vertical window seals 119, 120 (as depicted in FIGS. 2A, 2B) are secured to the vehicle body 108; although the use of other doorframe structures is also contemplated.

Referring to FIG. 2A, partial cross sectional view of the motor vehicle body 108 including an embedded roof rail mounting system 102 is depicted in accordance with an embodiment of the disclosure. In some embodiments, the embedded roof rail mounting system 102 can include an embedded roof rail mount 122, for example in the form of a T-stud or other lug secured to the vehicle body 108. For example, in one embodiment, the embedded roof rail mount 122 can include a two-part assembly T-stud in which an outer sheath 124 is inserted into an aperture defined in the vehicle body, and an inner stud 126 is forcibly positioned within the outer sheath 124, thereby causing the outer sheath 124 to expand about its perimeter so as to securely fastened the embedded roof the rail mount 122 with respect to the vehicle body 108. Other configurations of the embedded roof rail mount 122 are also contemplated.

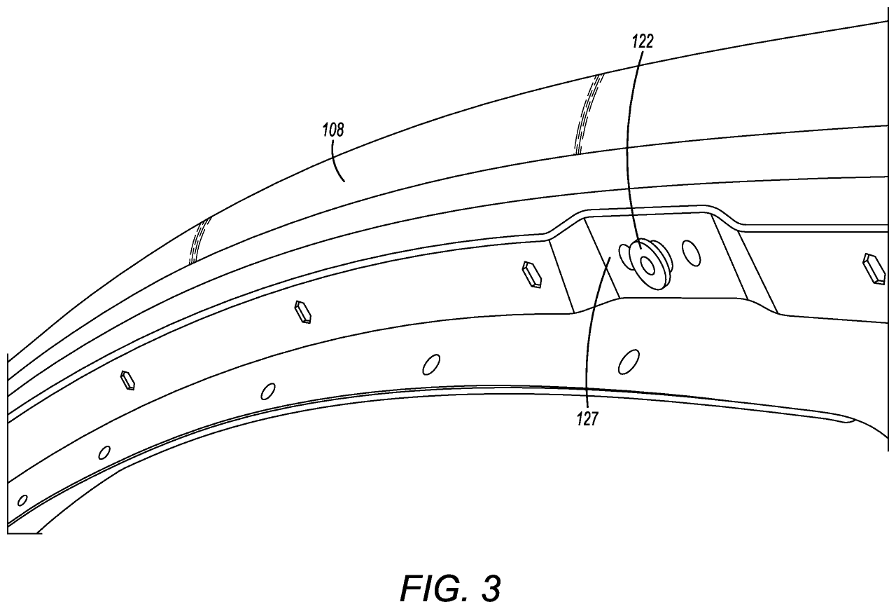

With additional reference to FIG. 3, a roof rail mount 122 fixedly coupled to a vehicle body 108 is depicted in accordance with an embodiment of the disclosure. As depicted, in some embodiments, the roof rail mount 122 can be positioned within a detent or recess 127 defined by an exterior of the vehicle body 108, thereby enabling easier access to the roof rail mount 122 when selectively coupling a roof rack 104 to the motor vehicle 100.

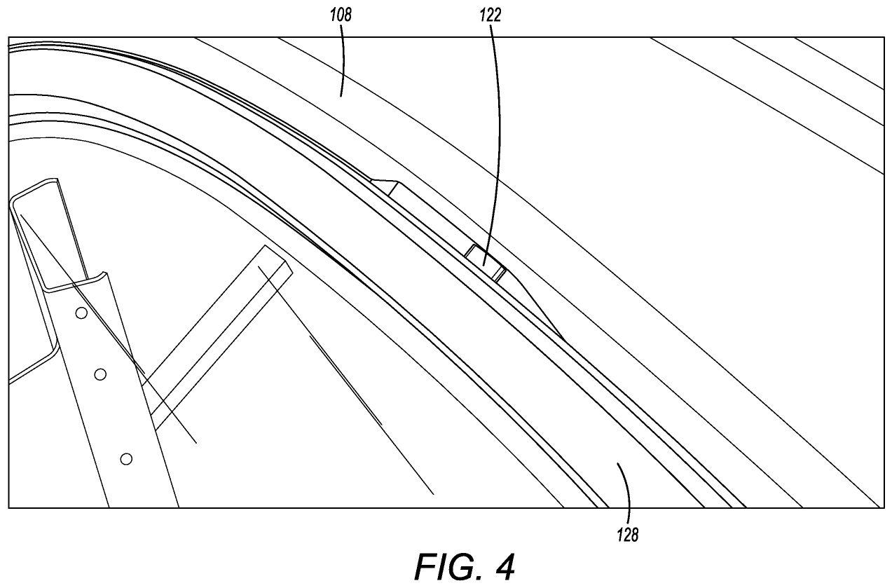

In some embodiments, a roof finisher 128, sometimes referred to as a drip rail, can be operably coupled to the vehicle body 108. The roof finisher 128 can serve to give the motor vehicle 100 a more finished look, as well as to provide a surface onto which the upper window seal 119 can be operably coupled. In some embodiments, a rivet or other type of faster 130 can be used to operably couple the roof finisher 128 to the vehicle body 108. For example, in some embodiments, the faster 122 can pass through an aperture defined in the roof finisher 128 and into a receiving aperture 134 of the embedded roof rail mount 122, thereby coupling the roof finisher 128 to the vehicle body 108; although connection methods are also contemplated. With additional reference to FIG. 4, a perspective view of a roof rail mount 122 secured to a vehicle body 108, located partially beneath a roof finisher 128, is depicted in accordance with an embodiment of the disclosure.

In some embodiments, the roof finisher 128 can be formed by an extrusion process, such that the roof finisher 128 includes one or more channels 136 configured to receive the upper window seal 119. In order to secure the upper window seal 119 in position relative to the roof finisher 128, in some embodiments, the channel 136 can include one or more tabs 138, 140 configured to interface with respective recesses or channels of the upper window seal 119. In some embodiments, the upper window seal 119 can be a two-part seal, including a base portion 142 having a first shore durometer hardness, and a window interface portion 144 having a second shore durometer hardness, wherein the window interface portion 144 has a lower shore durometer hardness (e.g., is softer) than the base portion 142.

A vertical window seal 120 can be operably coupled to the vehicle body 108 adjacent to the upper window seal 119. In some embodiments, the vertical window seal 120 can include a base portion 154 having a first shore durometer hardness, and a window interface portion 156 having a second shore durometer hardness, wherein the window interface portion 156 has a lower shore durometer hardness (e.g., is softer) than the base portion 154. The base portion 154 can define a channel 158 configured to receive a portion of the vehicle body 108, thereby securing the vehicle window seal 120 to the vehicle body 108. In some embodiments, the channel 158 can optionally include one or more tabs 160, 162 and/or one or more ribbed surfaces 164 to enhance a frictional interference between the vehicle body 108 and the vertical window seal 120. Further, in some embodiments the base portion 154 can include a reinforced portion 165 constructed of a semi-rigid material configured to inhibit deformation of the base portion 154 to promote a continuous frictional interference between the channel 158 and the vehicle body 108.

The upper window seal 119 and vertical window seal 120 can cooperate to form a seal between the respective upper and internal vertical edge of the window 118, thereby inhibiting moisture intrusion into the interior (e.g., cabin) of the vehicle 100. In addition to inhibiting the intrusion of water into an interior of the vehicle, the upper and vertical window seals can serve to reduce road noise observable by occupants within the vehicle during operation. For improved road noise reduction, in some embodiments, the upper window seal 119 and the vertical window seal 120 can overlap, for example via a tab 167 extending from the upper window seal 119, thereby creating a pocket 169 entirely surrounded by at least one of a portion of the upper window seal 119, the vertical window seal 120 or the window 118.

In some embodiments, the roof finisher 128 can include one or more channels 146 configured to receive a flip seal 148. The flip seal 148 can generally be configured to create at least the appearance of a contiguous surface between the roof finisher 128 and the vehicle body 108, so as to conceal the embedded roof rail mount 122 from an exterior of the vehicle.

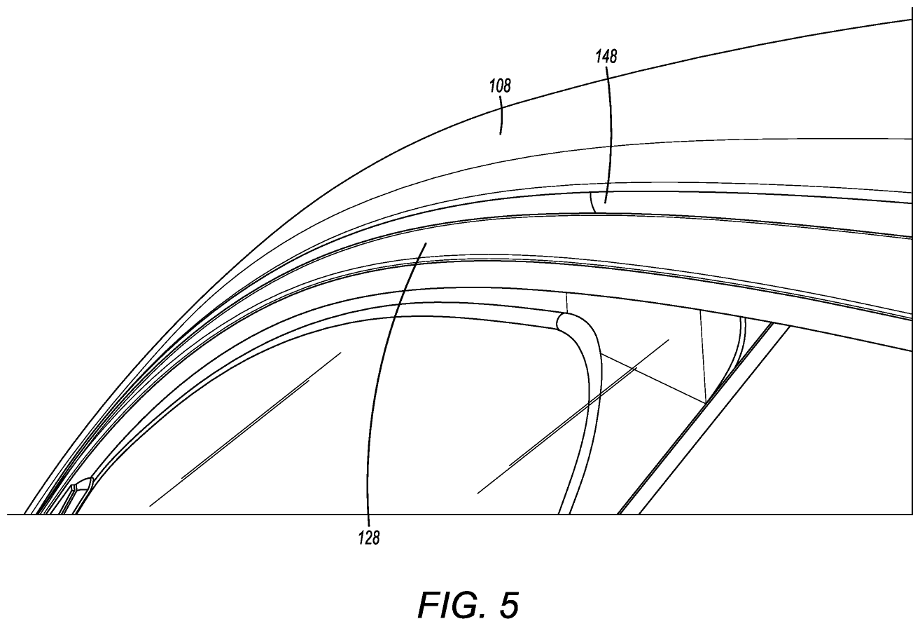

With additional reference to FIG. 5, a perspective view of a vehicle body 108 including a roof rail mount 122 concealed beneath a resilient flip seal 148, is depicted in accordance with an embodiment of the disclosure. With continued reference to FIG. 2B, in order to secure the flip seal 148 in position relative to the roof finisher 128, the channel 146 can include one or more tabs 150, 152 configured to interface with respective recesses or channels of the flip seal 148.

With further reference to FIG. 2B, when a user desires to selectively couple a roof rack 104 to the motor vehicle 100, the flip seal 148 can be temporarily deformed or otherwise pulled away from the vehicle body 108 thereby exposing the embedded roof rail mount 122. Thereafter, and end region 112 of a rigid rail can be inserted into the space between the vehicle body 108 and the flip seal 148, so as to tuck under a portion of the embedded roof rail mount 122. Accordingly, in some embodiments, the outer sheath 124 of the roof rail mount 122 can include a flanged head 164 defining a recess 166 into which a portion of an end region 112 of the rigid rail 106 can be positioned, thereby securing the rigid rail 106 to the vehicle body 108.

As an aid in retaining the end region 112 of the rigid rail 106 within the recess 166, in some embodiments, the roof rack 104 can include one or more clapping mechanisms configured to apply a tensile force lengthwise along the rigid rail 106. As depicted in FIG. 2B, in some embodiments, roof rail mount 122 can extend downwardly and outwardly from an exterior of the vehicle body 108, such that the roof rail mount 122 extends at an oblique angle Θ with respect to a lateral axis (y-axis) of the vehicle 100. For example, in one embodiment, the oblique angle Θ can range from between about 100° and about 140° (e.g., between about 110° and about 130°; or about 120°), such that a tension applied to the roof rail 106 along the length of the rigid rail 106 generally has the effect of maintaining a positive force between a respective end portion of the rigid rail 106 and the roof rail mount 122.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An embedded roof rail mounting system for a motor vehicle, the embedded roof rail mounting system comprising:
a roof rail mount operably coupled to a vehicle body, the roof rail mount including a flanged head defining a recess shaped and sized to accommodate a portion of a roof rail; and
a flip seal constructed of a resilient material configured to conceal the roof rail mount below an exterior surface of the motor vehicle.

2. The embedded roof rail mounting system of claim 1, wherein the roof rail mount is formed of a two-part T-stud assembly, comprising an inner stud positionable within an outer sheath, wherein positioning the inner stud within the outer sheath causes a perimeter of the outer sheath to expand.

3. The embedded roof rail mounting system of claim 1, wherein the roof rail mount is positioned within a recess of the vehicle body.

4. The embedded roof rail mounting system of claim 1, further comprising a roof finisher operably coupled to the roof rail mount.

5. The embedded roof rail mounting system of claim 4, wherein the roof finisher is operably coupled to the roof rail mount via a fastener passing through the roof finisher and received within a portion of the roof rail mount.

6. The embedded roof rail mounting system of claim 4, wherein the roof finisher defines a first channel configured to receive an upper window seal.

7. The embedded roof rail mounting system of claim 6, further comprising a vertical window seal operably coupled to the vehicle body adjacent to the upper window seal.

8. The embedded roof rail mounting system of claim 7, wherein the upper window seal and the vertical window seal are arranged in an overlapping configuration.

9. The embedded roof rail mounting system of claim 1, wherein the roof finisher defines a second channel configured to receive the flip seal.

10. The embedded roof rail mounting system of claim 1, wherein the flip seal is deformable to provide selective access to the roof rail mount from an exterior surface of the vehicle.

11. The embedded roof rail mounting system of claim 1, wherein the roof rail mount extends at an oblique angle with respect to a lateral axis of the vehicle body.

12. The embedded roof rail mounting system of claim 11, wherein the oblique angle is in a range of between about 100° and about 140°.

13. A motor vehicle including an embedded roof rail mounting system configured to enable selective attachment of one or more roof rails to respective roof rail mounts hidden beneath an exterior surface of the motor vehicle, the motor vehicle comprising:
a motor vehicle body;
two or more roof rail mounts operably coupled to the motor vehicle body, each roof rail mount including a flanged head defining a recess shaped and sized to accommodate a portion of a roof rail; and
a flip seal on each side of the motor vehicle body constructed of the resilient material configured to conceal the two or more roof rail mounts below an exterior surface of the motor vehicle body.

14. The motor vehicle of claim 13, wherein the roof rail mount is positioned within a recess of the motor vehicle body.

15. The motor vehicle of claim 13, further comprising a roof finisher operably coupled to the roof rail mount.

16. The motor vehicle of claim 15, wherein the roof finisher defines a first channel configured to receive an upper window seal.

17. The motor vehicle of claim 16, wherein the roof finisher defines a second channel configured to receive the flip seal.

18. The motor vehicle of claim 13, wherein the flip seal is deformable to provide selective access to the roof rail mount from an exterior surface of the motor vehicle body.

19. The motor vehicle of claim 13, wherein the roof rail mount extends at an oblique angle with respect to a lateral axis of the motor vehicle body.

20. An embedded roof rail mounting system for a motor vehicle, the embedded roof rail mounting system comprising:
a roof rail mount operably coupled to a recess of defined in the body of a motor vehicle, the roof rail mount including a flanged head defining a recess shaped and sized to accommodate a portion of a roof rail, wherein the roof rail mount is formed of a two-part T-stud assembly, comprising an inner stud positionable within an outer sheath, wherein positioning the inner stud within the outer sheath causes a perimeter of the outer sheath to expand, and wherein the roof rail mount extends at an oblique angle in a range of between about 100° and about 140° with respect to a lateral axis of the vehicle body;
a flip seal constructed of the resilient material configured to conceal the roof rail mount below an exterior surface of the body of a motor vehicle, wherein the flip seal is deformable to provide selective access to the roof rail mount from the exterior surface;
a roof finisher operably coupled to the roof rail mount via a fastener passing through the roof finisher and received within a portion of the roof rail mount, wherein the roof finisher defines a first channel configured to receive an upper window seal and a second channel configured to receive the flip seal; and
a vertical window seal operably coupled to the vehicle body adjacent to the upper window seal, wherein the upper window seal and the vertical window seal are arranged in an overlapping configuration.
